(19) United States
(12) Patent Application Publication
(10) Pub. No.: US 2006/0123233 A1
(43) Pub. Date: Jun. 8, 2006

(54) Methods, systems and computer program products for providing customized levels of security

(76) Inventor: Jeffrey A. Aaron, Atlanta, GA (US)

Correspondence Address: MYERS BIGEL SIBLEY & SAJOVEC, P.A., P.O. BOX 37428, RALEIGH, NC, 27627, US

(21) Appl. No.: 11/006,869

(22) Filed: Dec. 8, 2004

(51) Int. Cl. H04L 9/00

(52) U.S. Cl. 713/166

(57) ABSTRACT

Methods for storing data are provided including automatically determining a degree of security protection to be provided for data to be stored based on selectivity features associated with the data and/or an environment associated with the data. The selectivity features of the data and/or the environment indicate the degree of security protection to be provided to the data to be stored. Related systems and computer program products are also provided.

### FIELD OF THE INVENTION

This invention relates to methods, systems and computer program products related to data protection and, more particularly, to methods, systems and computer program products for providing security for data stored in memory.

### BACKGROUND OF THE INVENTION

Computing devices are used for providing a wide variety of applications support to users as well as for storing a wide variety of information. As used herein, the term “computing device” refers to any equipment with computational capability or that is integrated with equipment with computational ability. Accordingly, as used herein, a computing device can include one or more enterprise, application, personal, pervasive and/or embedded computer systems that perform computational operations and associated input and/or output devices or components thereof. Examples of computing devices, as used herein, include computer workstations, personal digital assistants, cell phones, email pagers, automobile navigation systems, and computer-controlled appliances.

As computing devices and application programs for the same evolve, the range of information that can be stored in or associated with the computing devices may become very large. As a result, the range of personal information, such as financial information, transmitted through and stored in these distributed networks is expanding and the potential consequences of misuse and/or exploitation of the stored information may be greater, therefore, increasing the importance of secure storage means.

Existing methods of securing stored data may include, for example, encrypting data stored on a hard drive, storing data at a “secure” location and/or storing data in a protected database. However, as a level of security provided for the stored data increases, the cost of providing the increased security may also increase due to additional processing and monitoring that may be needed to implement the increased level of security. Furthermore, the amount of data that may need protection is growing rapidly and, thus, the total mount of data that may require security may eventually become extremely large, representing a significant total aggregate cost of data security. For large amounts of data, the increase in cost to provide highly secure storage may be more than most companies, groups, individuals and the like are willing to pay. Accordingly, improved methods of providing secure storage means may be desired.

### SUMMARY OF THE INVENTION

Some embodiments of the present invention provide methods for storing data including automatically determining a degree of security protection to be provided for data to be stored based on selectivity features associated with data and/or an environment associated with the data. The selectivity features of the data and/or the environment indicate the degree of security protection to be provided to the data to be stored.

In further embodiments of the present invention, a request to store the data may be received and the selectivity features may be extracted from the data and/or the environment. In these embodiments of the present invention, a level of security protection associated with ones of the extracted selectivity features may be determined and the degree of security protection to be provided to the data may be determined based on the determined levels of security protection. In certain embodiments of the present invention, the degree of security protection provided for the data may correspond to a highest level of security protection determined for the ones of the extracted selectivity features. In further embodiments of the present invention, one or more security application rules may be applied to the extracted selectivity features having corresponding determined levels of security protection and the degree of security protection to provide to the data may be determined based on an outcome of the security application rules.

In still further embodiments of the present invention, the determined degree of security protection may be applied to the data and the data with the determined degree of security protection may be stored. In certain embodiments of the present invention, the determined degree of security protection may be translated into a format that is usable by the storage device and/or a storage application so as to allow provision of the determined degree of security protection. The translated determined degree of security protection may include using a defense encryption standard (DES) and/or an advanced encryption standard (AES), using a means of encryption with a particular encryption key length and/or using a protected data location. The data may be stored responsive to the received request to store the data and the selectivity features may be extracted at a time of the request to store the data and/or continuously upon receipt and/or modification of the data to be stored.

In some embodiments of the present invention, the selectivity features associated with the data may include a type of data or data file and/or presence of sensitive content in the data. The selectivity features associated with the environment may include a source of the data, a destination of the data, a type of application that generated the data and/or a purpose of the data.

While described above primarily with reference to method aspects, it will be understood that the present invention further includes system and computer program product aspects.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of a data processing system suitable for use in some embodiments of the present invention.

FIG. 2 is a block diagram of a system for providing secure storage according to some embodiments of the present invention.

FIGS. 3-4 are flowcharts illustrating operations according to some embodiments of the present invention.

### DETAILED DESCRIPTION OF EMBODIMENTS OF THE PRESENT INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated selectivity features, integers, steps, operations, elements, and/or components, but do not preclude the presence or addition of one or more other selectivity features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

As discussed above, the amount and variety of data being stored on computing devices is increasing and the security provided to this data ranges broadly. When the amount of data being stored is small, the cost of increasing the amount of security provided to the data may be insignificant. But, if the amount of data being stored is large, the cost of increasing the amount of security may be significant. For example, if any of the data being stored is highly confidential, the highest degree of security may be applied to the highly confidential data. Without a means for determining a specific amount of security to be applied to specific data, the highest degree of security may be applied to all stored data, which may increase the cost of security even further. Furthermore, it may be inefficient to provide the highest degree of security to data which does not need that level of security, yet this may be the only safe/secure approach when a specific degree of protection is not available due to the inability to identify that specific degree.

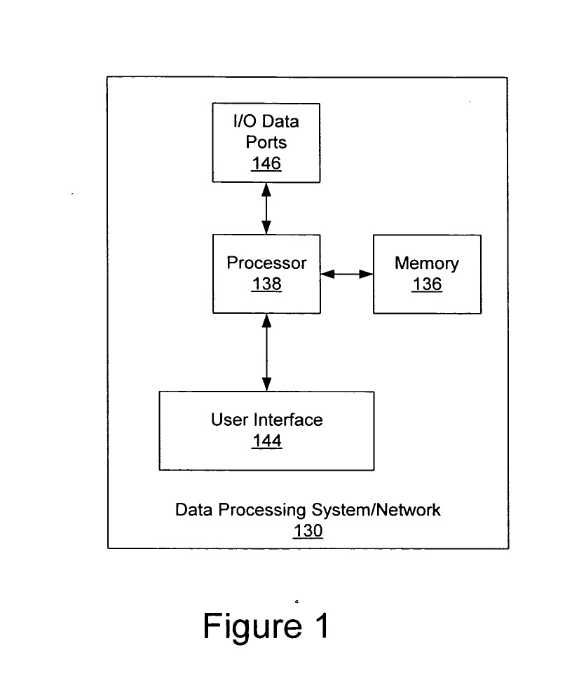

Thus, embodiments of the present invention that will be discussed with respect to FIGS. 1 through 4, provide methods, systems and computer program products for determining a specific degree of security protection for specific data. As used herein “data” refers to a data stream, a data file, a data packet or any format for transmitting and/or receiving data known to those having skill in the art. As discussed herein, the degree of security protection may be automatically determined based on selectivity features of the data and/or the environment. Thus, a precise amount of security protection may be applied to each specific piece of data, which may allow a significant reduction in the cost of securing data as discussed further herein.

FIG. 1 illustrates an exemplary embodiment of a computing device or data processing system 130 configured in accordance with some embodiments of the present invention. The data processing system 130, which may be incorporated in, for example, a personal computer, a PDA, a wireless terminal/phone, a smart appliance or the like, may include a user interface 144, including, for example, input device(s) such as a keyboard or keypad, a display, a speaker and/or microphone, and a memory 136 that communicate with a processor 138. The data processing system 130 may further include an I/O data port(s) 146 that also communicates with the processor 138. The I/O data ports 146 can be used to transfer information between the data processing system 130 and another computer system or a network using, for example, an Internet Protocol (IP) connection. These components may be conventional components such as those used in many conventional data processing systems, which may be configured to operate as described herein.

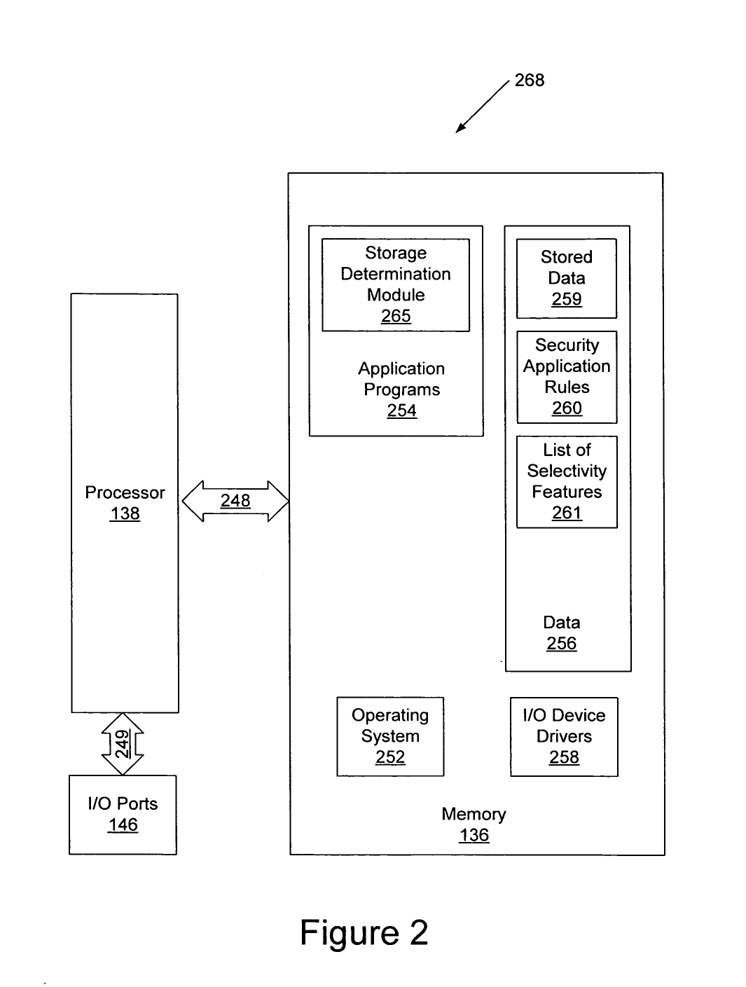

Referring now to FIG. 2, a block diagram of a system 268 for securely storing data is provided that illustrates systems, methods, and computer program products in accordance with some embodiments of the present invention will be discussed. As illustrated in FIG. 2, the processor 138 communicates with the memory 136 via an address/data bus 248. The processor 138 can be any commercially available or custom enterprise, application, personal, pervasive and/or embedded microprocessor, microcontroller, digital signal processor or the like. The memory 136 may include any memory devices containing the software and data used to implement the functionality of the data processing system 130. The memory 136 can include, but is not limited to, the following types of devices: ROM, PROM, EPROM, EEPROM, flash memory, SRAM, and DRAM.

As further illustrated in FIG. 2, the memory 136 may include several categories of software and data used in the system 268: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP, or Windows CE from Microsoft Corporation, Redmond, Wash., Palm OS, Symbian OS, Cisco IOS, VxWorks, Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various selectivity features of the system 268 and preferably include at least one application that supports operations according to embodiments of the present invention. Finally, as illustrated the data 256 may include stored data 259, security application rules 260 and one or more lists of selectivity features 261, which may represent the static and dynamic data used by the application programs 254, the operating system 252, the I/O device drivers 258, and other software programs that may reside in the memory 136.

While the present invention is illustrated with reference to the security determination module 265 being an application program in FIG. 2, as will be appreciated by those of skill in the art, other configurations fall within the scope of the present invention. For example, rather than being an application program 254, the security determination module 265 may also be incorporated into the operating system 252 or other such logical division of the system 268. Furthermore, while the security determination module 265 is illustrated in a single system 268, as will be appreciated by those of skill in the art, such functionality may be distributed across one or more systems. Thus, the present invention should not be construed as limited to the configuration illustrated in FIG. 2, but may be provided by other arrangements and/or divisions of functions between data processing systems. For example, although FIG. 2 is illustrated as having various circuits, one or more of these circuits may be combined without departing from the scope of the present invention.

As further illustrated in FIG. 2, according to some embodiments of the present invention the application programs 254 include a security determination module 265. The security determination module 265 may be configured to automatically determine a degree of security protection to be provided for data to be stored based on selectivity features of the data and/or an environment associated with the data. As used herein “a degree of security protection” refers to a type and/or a level of security mechanism to be applied to the data. For example, the type of security mechanism may include encryption keys, encryption algorithms, location of storage database, for example, a protected and/or monitored database, and the like. The level of security mechanism may include a length of the encryption key, for example, short, medium and long, use of a defense encryption standard (DES) or an advanced encryption standard (AES) and the like.

For example, in some embodiments of the present invention, multiple levels of security protection may be provided. A first level may be to not apply any encryption, i.e., this data is not very important. A second level may be to apply DES with a short encryption key. A third level may be to apply DES with a medium encryption key. A fourth level may be to apply DES with a long encryption key. The fifth level may be to apply AES with a short encryption key. A sixth level may be to apply AES with a medium encryption key. A seventh level may be to apply AES with a long encryption key. An eighth level may be the seventh level plus store the data in a protected location or database that may be closely monitored by security personnel. It will be understood that any of these levels of security protection may be combined or otherwise modified to create a new level of security protection. It will be further understood that the levels of security provided herein are provided for exemplary purposes only and that embodiments of the present invention are not limited to the examples provided herein.

The selectivity features of the data and/or the environment may indicate the degree of security protection to be provided to the data. As used herein “selectivity features” refer to any selectivity feature that can be extracted from or recognized in the data itself or the environment that may indicate the importance of the data. For example, the selectivity features associated with the data may include a type of data or data file, such as a financial file, and/or presence of sensitive content in the data. As used herein, “sensitive content” may include, for example, keywords, phrases, titles, markings, such as SENSITIVE, or the like. It will be understood that the absence of sensitive content may be a selectivity feature, just as the presence of the sensitive content may also be a selectivity feature. The selectivity features associated with the environment may include a source of the data, such as a bank, a destination of the data, such as a personal finance document, a type of application that generated the data and/or a purpose of the data. It will be understood that the exemplary selectivity features set out herein are provided for exemplary purposes only and that embodiments of the present invention are not limited to these examples. One or more lists of selectivity features 261 may be stored in the memory 136.

In some embodiments of the present invention, the security determination module 265 may be configured to receive a request to store a data file. Thus, the security determination module 265 may be configured to identify selectivity features in or extract selectivity features from the data file and/or the environment. It will be understood that the identification of selectivity features in the data and/or the environment may be performed upon a request to store the data file or may be performed continuously, for example, when the data file is received and/or modified. Identifying the selectivity features when the data file is received and/or modified may, in some embodiments of the present invention, allow identification of selectivity features that may only be available in advance of a storage request. In other words, events may occur between receipt of the data file and a storage request that change the original content of the data file. For example, the data file may be altered/modified before the storage request is made and the alteration may remove or delete selectivity features that were once present in the data file.

Furthermore, in some embodiments of the present invention, the selectivity features may be identified both at the time of receipt or modification of the data file and at the time of the request for the storage of the data file. Identifying the selectivity features multiple times may allow any potential conflicts between the selectivity features identified upon receipt and the selectivity features identified upon request for storage. In some embodiments of the present invention, if a conflict occurs, the conflicting selectivity features identified at the time of receipt may be discarded. This may be due to the fact that the selectivity features extracted at the time of the storage request may be more current than those that were extracted at the time of receipt, which may no longer be accurate.

The selectivity features may be continuously detected (i.e. detected upon receipt/modification) by, for example, configuring the operating system to detect any data or data file being handled or being handled in a particular manner. For example, the operating system may be configured to detect the data file if the data is modified or altered, but not stored, or if the data is located in an email that is sent or received, but not stored. Furthermore, a unique identifier may be generated for the data file so as to keep track of the data file. For example, the data file or a pre-arranged repeatable portion thereof may be concatenated with the current date and time so as to allow a determination of when the data was received. The resulting string may be hashed using, for example, standard MD-5 or SHA-1 message digest algorithms, to produce a unique fixed length result. Finally, the selectivity features may be recorded in a database and may be indexed for retrieval. For example, the selectivity features may be organized into groups, such as data-internal, environment, network, wrapper, keywords, keyword groups and the like, and the groups of selectivity features may be stored.

The extraction of the selectivity features from the data or the environment may be performed in many ways that may be clear to those having skill in the art. For example, the selectivity features may be extracted from the data by, for example, detecting the data and copying/storing the data for use in subsequent processing as discussed above. A data type, such as spreadsheet, password, letter or memo, email and the like, may be identified as specifically as possible using the filename extension and/or format of the filename and/or file and/or the headers, footers and the like. Data fields may be examined to obtain matches to, for example, security application rules discussed further below. The data may be scanned/parsed for matches to sensitive content or keywords in any portion of the data.

The selectivity features may be extracted from the environment by, for example, detecting the date and time and/or detecting origin, destination, protocol, ports, the exact network if sent via a network communication. The operating system may be queried to obtain all pertinent information, such as currently active applications, specific operating system calls made about the environment and the like. Applications that are generating and/or receiving data may also be detected.

The security determination module 265 may be configured to determine a level of security protection associated with ones of the extracted selectivity features and determine the degree of security protection to be provided to the data based on the determined levels of security protection. The degree of security protection may be provided to the data based on the determined levels of security protection by, for example, applying the highest level of security protection determined associated with the extracted selectivity features, and applying security application rules to the determined levels to determine the degree of security protection, i.e., select highest level of security protection determined by the security application rules. For example, the selectivity features located in the data file may include the data strings “proprietary” and “Next Big Thing Project”, dollar signs and the selectivity features associated with the environment may be that the data file has been received from accounting. The string “proprietary” may be assigned a level four protection level, the string “next big thing project” may be assigned a level three protection level, the dollar signs may be assigned a level two protection level and the fact that the file is from accounting may be assigned a level one protection level. In some embodiments of the present invention, the degree of security protection provided to this data file may be the highest level determined based on the selectivity features, i.e., a level four of the “proprietary” string in this example. In further embodiments of the present invention, security application rules 260 may be applied to determine the degree of security protection for the file. For example, security application rules may include: Rule 1=“proprietary”+dollar signs=level 5; Rule 2=“next big thing project”+Accounting=level 7. Thus, the highest level determined by the security application rules may be applied as the degree of security protection, i.e., level 7 in this example. It will be understood that any reasonable method of combining the results of the various security application rules to determine the degree of security protection to be provided may be used without departing from the scope of the present invention.

The security determination module 265 may be further configured to indicate the determined degree of security protection in a format that is usable by the storage device such that the data may be stored with the proper degree of security protection in the stored data 259 portion of the memory 138. In some embodiments of the present invention, the security determination module 265 may be configured to translate the determined degree of security protection to an externally usable form, such as a type of encryption, for example, DES or AES, the length of the encryption key, such as short, medium or long, and/or a location of secure storage. This externally recognizable form may be provided with the data file to a storage application, function or operating system to be stored (stored data 259) so as to allow the data to be stored with the appropriate degree of security protection. It will be understood that although the security determination module 265 is illustrated herein as a separate module, embodiments of the present invention are not limited to this configuration. For example, the security determination module 265 may be included in the actual storage application without departing from the scope of the present invention.

Embodiments of the present invention will now be discussed with respect to the following example. The Amalgamated Metals Company has purchased automatic storage security products according to some embodiments of the present invention. The products have been installed on some of Amalgamated's computing devices. Pat Smith, in Research and Development, receives an email attachment from Roger Penrose, in Accounting. The security determination module 265, according to some embodiments of the present invention, is configured to detect the originator of the message (Roger) and maintains an index record containing this selectivity feature. Pat edits the file on his personal computer and requests that the edited file be stored by, for example, clicking on an appropriate application menu choice or item. The Security determination module 265 is configured to detect the storage request and extracts the selectivity features from the email and identifies the selectivity features related to the environment, such as currently active applications. The security determination module 265 processes the selectivity features including any previously identified selectivity features (i.e., the file is from Roger in Accounting). The security determination module 265 may also note that the email is a spreadsheet with dollar figures and includes keywords/phrases indicating an important R&D project. Furthermore, the security determination module 265 may be configured to recognize that the file was edited while another application was open to view another file previously stored with high security. The security determination module 265 is configured to determine the degree of security protection to be provided to the file and may translate the degree of security protection into a format usable by the storage device. The file may be stored having the determined degree of security protection. For example, this file may be deemed extremely sensitive and may be stored on a central R&D server which may be closely monitored and strongly protected, rather than being stored on Pat's PC.

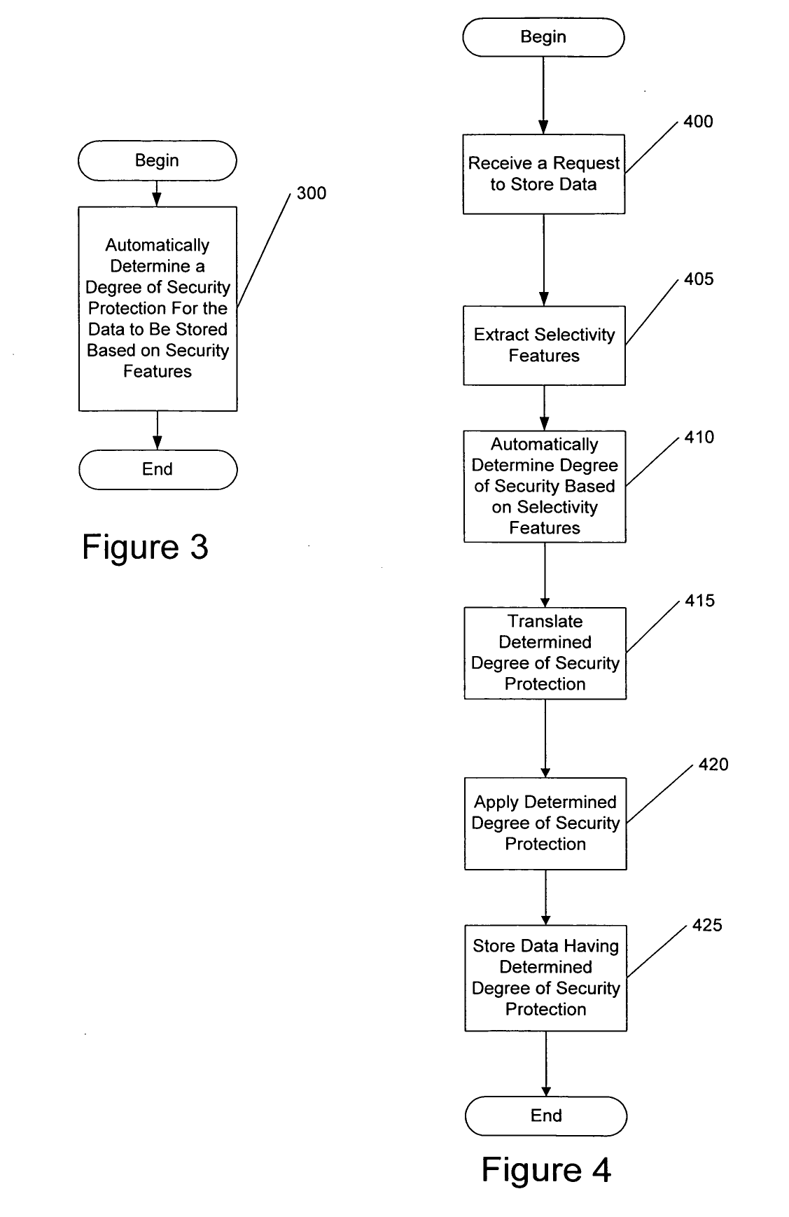

Operations according to various embodiments of the present invention will now be further described with reference to the flow chart illustrations of FIGS. 3 and 4. Referring first to FIG. 3, methods for securely storing data will be discussed. Operations begin at block 300 by automatically determining a degree of security protection to be provided for data to be stored based on selectivity features associated with the data and/or an environment associated with the data. As discussed above, the selectivity features of the data and/or the environment may indicate the degree of security protection to be provided to the data. The selectivity features may be identified and/or extracted at the time of a storage request from the computing device or continuously, for example, at the time of receipt and/or each time the data is modified or altered. In embodiments of the present invention that identify the selectivity features continuously, the identified/extracted selectivity features may be stored for use at the time of the storage request.

Referring now to FIG. 4, operations for securely storing data according to further embodiments of the present invention will be discussed. Operations begin at block 400 by receiving a request that data be stored. In some embodiments of the present invention, the request may be received at the computing device from an operating system. Furthermore, in some embodiments of the present invention the request may be received at a separate security determination module or the security determination module may be integrated with the actual storage location without departing from the teachings of the present invention. Selectivity features may be identified and/or extracted from the data requested to be stored or the environment associated with the data (block 405). As discussed above, the selectivity features may be identified/extracted at the time the request to store the data is received or continuously without departing from the scope of the present invention.

A level of security protection associated with the ones of the identified/extracted selectivity features may be determined. For example, in some embodiments of the present invention there may be eight levels of security protection. Thus, in these embodiments of the present invention, each of the identified/extracted selectivity features may be assigned a level from 1 to 8. The degree of security protection to be provided to the data may be determined based on the determined levels of security protection (block 410). For example, in some embodiments of the present invention, the highest level of security protection identified with respect to the selectivity features may be applied to the entire data. In further embodiments of the present invention, the degree of security protection may be determined based on one or more security application rules associated with the identified/extracted selectivity features. The identified selectivity features and the security application rules may be stored in the memory of one or more computing devices.

Once the degree of security protection to be applied to the data is determined, the degree of security protection may be translated to convey useful information to the storage device (block 415). For example, a level 1 security may be translated to DES with a short encryption key length. The determined degree of security protection may be applied to the data (block 420) and the data may be stored having the determined degree of security protection (block 425).

As discussed briefly above with respect to FIGS. 1 through 4, some embodiments of the present invention provide methods, systems and computer program products for providing customized levels of security to data requested to be stored. Thus, each time data is requested to be stored, an individual determination of the degree of security protection for that data may be made. Thus, only the amount of protection needed for that particular data may be applied. Accordingly, data may be securely stored without a significant increase in cost.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method for securely storing data comprising automatically determining a degree of security protection to be provided for data to be stored based on selectivity features associated with the data and/or an environment associated with the data, the selectivity features of the data and/or the environment indicating the degree of security protection to be provided to the data to be stored.

2. The method of claim 1, wherein automatically determining is preceded by:
receiving a request to store the data; and
extracting the selectivity features from the data and/or the environment, wherein automatically determining further comprises determining a level of security protection associated with ones of the extracted selectivity features and determining the degree of security protection to be provided to the data based on the determined levels of security protection.

3. The method of claim 2, wherein the degree of security protection provided to the data corresponds to a highest level of security protection associated with the ones of the extracted selectivity features.

4. The method of claim 2, wherein determining the degree of security protection to be provided to the data based on the determined levels of security protection comprises applying one or more security application rules to the extracted selectivity features having corresponding determined levels of security protection and determining the degree of security protection to provide to the data based on an outcome of the security application rules.

5. The method of claim 2, wherein determining is followed by:
applying the determined degree of security protection to the data; and
storing the data with the determined degree of security protection.

6. The method of claim 5, wherein applying further comprises translating the determined degree of security protection into a format that is usable by the storage device and/or a storage application so as to allow provision of the determined degree of security protection and wherein the translated determined degree of security protection comprises using a defense encryption standard (DES) and/or an advanced encryption standard (AES), using a means of encryption with a particular encryption key length and/or using a protected data location.

7. The method of claim 5, wherein storing further comprises storing the data responsive to the received request to store the data and wherein extracting the selectivity features comprises extracting the selectivity features at a time of the received request to store the data and/or continuously extracting the selectivity features upon receipt and/or modification of the data to be stored.

8. The method of claim 1, wherein the selectivity features associated with the data comprise a type of data or data file and/or presence of sensitive content in the data and wherein the selectivity features associated with the environment comprise a source of the data, a destination of the data, a type of application that generated the data and/or a purpose of the data.

9. A system for securely storing data comprising a security determination module configured to automatically determine a degree of security protection to be provided for data to be stored based on selectivity features associated with the data and/or an environment associated with the data, the selectivity features of the data and/or the environment indicating the degree of security protection to be provided to the data to be stored.

10. The system of claim 9, wherein the security determination module is further configured to:
receive a request to store the data;
extract the selectivity features from the data and/or the environment;
determine a level of security protection associated with the ones of the extracted selectivity features; and
determine the degree of security protection to be provided to the data based on the determined levels of security protection.

11. The system of claim 10, wherein the system further comprises a storage database and wherein the security determination module is further configured to:
apply the determined degree of security protection to the data; and
provide the data with the determined degree of security protection to the storage database

12. The system of claim 9, wherein the security determination module is further configured to translate the determined degree of security protection into a format that is usable by the storage device and/or a storage application so as to allow provision of the determined degree of security protection and wherein the translated determined degree of security protection using a defense encryption standard (DES) and/or an advanced encryption standard (AES), using a means of encryption with a particular encryption key length and/or using a protected data location.

13. The system of claim 9, wherein the selectivity features associated with the data comprise a type of data or data file and/or presence of sensitive content in the data and wherein the selectivity features associated with the environment comprise a source of the data, a destination of the data, a type of application that generated the data and/or a purpose of the data.

14. A computer program product for securely storing data, the computer program product comprising:
a computer readable medium having computer readable program code embodied therein, the computer readable program product comprising:
computer readable program code configured to automatically determine a degree of security protection to be provided for data to be stored based on selectivity features associated with the data and/or an environment associated with the data, the selectivity features of the data and/or the environment indicating the degree of security protection to be provided to the data to be stored.

15. The computer program product of claim 14, further comprising:
computer readable program code configured to receive a request to store the data; and
computer readable program code configured to extract the selectivity features from the data and/or the environment, wherein the computer readable program code configured to determine further comprises computer readable program code configured to determine a level of security protection associated with ones of the extracted selectivity features and determine the degree of security protection to be provided to the data based on the determined levels of security protection.

16. The computer program product of claim 15, wherein the degree of security protection corresponds to a highest level of security protection determined for the ones of the extracted selectivity features.

17. The computer program product of claim 15, wherein the computer readable program code configured to determine the degree of security protection to be provided to the data based on the determined levels of security protection further comprises computer readable program code configured to apply one or more security application rules to the extracted selectivity features having corresponding determined levels of security protection and computer readable program code configured to determine the degree of security protection to provide to the data based on an outcome of the security application rules.

18. The computer program product of claim 15, further comprising:
computer readable program code configured to apply the determined degree of security protection to the data; and
computer readable program code configured to store the data with the determined degree of security protection.

19. The computer program product of claim 18, wherein the computer readable program code configured to apply further comprises computer readable program code configured to translate the determined degree of security protection into a format that is usable by the storage device and/or a storage application so as to allow provision of the determined degree of security protection and wherein the translated determined degree of security protection comprises using a defense encryption standard (DES) and/or an advanced encryption standard (AES), using a means of encryption with a particular encryption key length and/or using a protected data location.

20. The computer program product of claim 18, wherein the computer readable program code configured to store further comprises computer readable program code configured to store the data responsive to the received request to store the data and wherein the computer readable program code configured to extract the selectivity features comprises computer readable program code configured to extract the selectivity features at a time of the request to store the data and/or continuously extracting the selectivity features upon receipt and/or modification of the data to be stored.
